(19) United States
(12) Patent Application Publication
(10) Pub. No.: US 2011/0233802 A1
(43) Pub. Date: Sep. 29, 2011

(54) SYSTEM FOR REPAIRING BREAKS IN THERMOPLASTIC PARTS

(76) Inventor: Evan ESTRATE, Lorton, VA (US)

(21) Appl. No.: 13/036,707

(22) Filed: Feb. 28, 2011

Related U.S. Application Data
(60) Provisional application No. 61/309,240, filed on Mar. 1, 2010.

(51) Int. Cl. B29C 73/00; B32B 3/02

(52) U.S. Cl. 264/36.1; 425/11; 428/141; 428/81

(57) ABSTRACT

Thermoplastic body parts can be repaired by (a) heating a shaped staple to a temperature that is above the melt point of the thermoplastic component and (b) embedding the shaped staple across the crack seam and into the thermoplastic component material on either side of the crack seam. When cooled, the shaped staple will span the crack seam and be firmly embedded in the component material on either side thereof. The use of a plurality of such shaped staples along the length of the crack seam will permit the crack to be secured in a structurally significant manner and, with proper selection of the staple thickness and material, permit the crack to be filled, sanded and finished in a manner that does not pose a seam of continued structural weakness for the repaired component.

### FIELD OF THE INVENTION

The invention relates to methods, systems and components that are useful for repairing cracked or split plastic components that can be melted and solidified, such as automobile panels or bumpers.

### BACKGROUND OF THE INVENTION

Front and rear bumpers on today's cars generally consist of a plastic cover over a reinforcement bar made of steel, aluminum, fiberglass composite, or plastic. The majority of modern plastic car bumper system fascias are made of thermoplastic olefins (TPOs), polycarbonates, polyesters, polypropylene, polyurethanes, polyamides, or blends of these with, for instance, glass fibers, for strength and structural rigidity. Polypropylene foam or formed thermoplastic sometimes is used in addition to or instead of crushable brackets and a bar, but their main purpose is to serve as a spacer between the bar and the bumper cover rather than as an energy absorber. Very few bumper bars are attached to the vehicle structure through mechanisms like shock absorbers.

The use of plastic materials in auto bumpers and fascias gives designers a tremendous amount of freedom when it comes to styling a prototype vehicle, or improving an existing model. See, for example, U.S. Pat. No. 6,136,249 entitled “Process for Forming Automobile Bumper Made of Synthetic Resin” whose disclosure is incorporated herein by reference. Plastic can be styled for both aesthetic and functional reasons in many ways without greatly affecting the cost of production. Plastic bumpers contain reinforcements that allow them to be as impact-resistant as metals while being less expensive to replace than their metal equivalents. Plastic car bumpers generally expand at the same rate as metal bumpers under normal driving temperatures and do not usually require special fixtures to keep them in place.

An automobile's thermoplastic components, like bumpers and side panels, are designed to absorb impact forces during a collision. Such bumpers can withstand the impact at net speeds of from 5 to 15 miles per hour without significant damage. However, more substantial impact speeds often result in distortion, cracking, ripping or tearing of the plastic bumper. Heretofore, such bumpers were difficult to repair in a structurally meaningful way and had to be replaced at substantial expense.

Adhesives are generally not useful to repair a cracked or split thermoplastic bumper or panel in a manner that is both durable and structurally adequate. One reason is that the surface area presented by the damaged edge of the formed material is usually quite small in total area. Available adhesives do not exhibit an adequately high bonding force and internal structural toughness to exert sufficient force across the edge area to hold the edges together.

To some extent, the surface area can be increased by extending the adhesive onto the surrounding area around the crack to form an elevated surface. Such a build-up would have to be on the reverse side of the cracked component to avoid a noticeable defect in a desirably smooth surface in the repaired and finished exterior surface of the component. The success of the adhesive thus depends on its ability to adhere to the rear surface of the repaired panel and to provide a structurally sound bridge across the crack in the underlying material.

Unfortunately, adhesives do not usually exhibit the same level of strength and toughness as the underlying component material. Any adhesive will also require that the adhesion surface be properly prepared to remove as much of the mold release agent as possible that is used in the bumper component material. Even if properly formed and adhered, the adhesive-repaired crack will represent a continuing seam of weakness that will either break again or flex more than the surrounding areas so as to subject any applied finish to unusually high flexure forces that will reveal the weakness by surface cracks or repeated failure.

An alternative to adhesive-based repair is the use of controlled heating and re-forming of the thermoplastic material. Such many bumpers and automotive panels are made with some form of polypropylene, rubber-modified polypropylene or the like that can be “welded” if there is enough material and carefully controlled conditions (usually requiring a shaped jig to hold the part and retain its intended form during the welding process). The welding process and associated jigs are both complicated and require highly skilled operators to weld an appropriate seam in a bumper that will be both durable and structurally tough.

### SUMMARY OF THE INVENTION

It is an objective of the present invention to provide a system, method and articles that are useful for repairing cracked, ripped, torn or otherwise broken thermoplastic parts, such as automobile bumpers, body panels, fascia and similar aesthetic parts, in a manner that restores a large measure of the original structural integrity and durability of the part.

It is a further objective to provide a repair system and method that is inexpensive and can be used in automobile body repair shops of any size with even inexperienced personnel given minimal training.

In accordance with these and other objectives of the invention that will become apparent from the description found herein, a method for repairing a defect in a thermoplastic automobile bumper according to the invention comprises the step of embedding a heated, shaped staple or plate across the defect area in an automobile bumper and into sound material on at least two sides of said defect area whereby, when cooled, the shaped staple or plate joins together the sound material across the defect area.

With the repair system of the present invention, the embedded staple acts as a structural bridge across the defect area and units the sound areas around the defect with a durable, structurally sound patch. This patch does not add unnecessary thickness to the part and can be further sanded, sealed and painted to make a repaired part that is durable and structurally tough.

### BRIEF DESCRIPTION OF THE DRAWINGS

FIGS. 1A-1F show a variety of suitable shapes for the embedded staples of the present invention. FIG. 1A is a top view of a staple exhibiting an infinity symbol shape. FIG. 1B a double “H” staple. FIG. 1C illustrates a “Z”-shaped staple with two vertical grips suitable for holding the staple during heating. FIG. 1D is a circular or “O”-shaped staple with two vertical grips having transverse members to help push the hot staple into the thermoplastic component of the repaired part. FIG. 1E depicts a double box-shaped staple with a score line as a separation seam for removing excess staples from a strip or roll of multiple, connected staples. FIG. 1F is a set of three “X”-shaped, interconnected staples which also have a score line between staples for separation of excess staples.

FIG. 2 illustrates a side view of the staple in FIG. 1A.

FIG. 3 depicts a variation of the infinity-shaped staple of FIGS. 1A and 2 which has one arm member that is bent perpendicular to the plane of the staple to form thereby a vertical grip for the staple.

FIG. 4 shows a side view of the Z-shaped staple of FIG. 1C with perpendicular extensions at the terminal ends of each leg to form a staple having two vertical grips.

FIG. 5 depicts a circular oside view of r O-shaped staple as in FIG. 1D with two L-shaped, perpendicularly extending vertical grip members.

FIG. 6 is a top view of a triple “H” shape of staple that has been stamped from metal stock of suitable shape.

FIG. 7 depicts an installation method that starts with a strip of infinity-shaped, interconnected staples having a vertical grip formed from the metal wire stock used to form the staple, insertion of a removed staple into a heating iron, and embedding the heated staple across the crack in a thermoplastic part, such as an automotive bumper.

FIGS. A and 8B depict top and side views, respectively, of a toothed plate that can be embedded across the defects of a cracked or broken plastic part.

FIGS. 9a and 9B illustrate a narrow staple that can flex so as to be used for repairing curved sections of a broken thermoplastic part.

### DETAILED DESCRIPTION OF THE INVENTION

The present invention provides a system, components and method for repairing cracks, splits and tears in thermoplastic body parts.

Thermoplastic body parts can be repaired according to the present invention by (a) heating a shaped staple to a temperature that is above the melt point of the thermoplastic component and (b) embedding the shaped staple across the crack seam and into the thermoplastic component material on either side of the crack seam.

When cooled, the shaped staple will span the crack seam and be firmly embedded in the component material on either side thereof. The use of a plurality of such shaped staples along the length of the crack seam will permit the crack to be secured in a structurally significant manner and, with proper selection of the staple thickness and material, permit the crack to be filled, sanded and finished in a manner that does not pose a seam of continued structural weakness for the repaired component.

The present invention provides the shaped staples in a configuration that will both span the break and provide sufficient surface area on either side of the spanning sections to permit the staple to become securely embedded within the thermoplastic material and resist separation. Such staples can be described as having (a) a central portion of a length sufficient to span a crack and (b) first and second terminal portions on either end of the central portion that may or may not have the same shape but which each present surface area of straight or curved shape that is within the range of more than zero but less than 180 degrees (e.g., 0°<x, y<180°) and that will resist removal by forces or movements that would open the crack spanned by the central portion. Exemplary shapes include many of the shapes found in symbols on a standard keyboard, e.g., 2, 3, 8, Q, E, O, S, D, G, Z, N, M, C, B and #; symbols found in science, mathematics, or typography, e.g., an infinity symbol (∞), double ended arrow ( [symbol] ), section symbol (§), and the “not equal to” symbol (≠). Also suitable are staples having configurations that, when provided in the form of a connected strip of separable staples, look like stitches that might be found on a sewing machine.

The shaped staples most suitable for a relatively thin panel, like an automotive body panel or shaped bumper within the range of about 2-10 mm in thickness, are generally formed as generally planar parts of a given material thickness that will lie generally flat in an X-Y plane. It is possible, however, to form the shaped staples so that they extend into the Z plane if the thickness of the component to be repaired is sufficiently thick to permit the staple to be properly embedded so that it does not protrude excessively above the surface of the repaired thermoplastic component. A suitable length in the Z axis is within the range from about 0 mm (flat staple or plate or co-planar extensions shaped to resist pull-out of the embedded staple) to about 10 mm with the specific length dependent on the thickness of the parts to be repaired.

It is desirable, although not necessary, that the shaped staples of the invention include at least one gripping member that extends in a generally Z axis away from the generally X-Y plane of the shaped staple. This gripping member can be used to hold an individual staple in the jaws of a pliers or similar tool as the staple is heated above the melting point of the cracked thermoplastic material. Once heated, the shaped staple is urged into the thermoplastic part so that the central portion of the staple spans the crack and each end or side melts its way into the component and becomes embedded therein. The staple will become permanently embedded into both sides of the crack.

Although the shaped staples of the present invention can be used and embedded individually, the repair process is performed more quickly if the shaped staples are provided (a) in the form of a connected strip of separable staples and/or (b) with at least one gripping member that extends in a generally Z axis from the generally X-Y axis of the individual staple. The strip format permits the installer to organize a plurality of shaped staples without entanglement, cut off unnecessary staples, and to install the staples at a regularly spaced interval between each staple for consistent strength along the repaired crack.

The gripping member or members can be used to hold the strip with a handheld tool for heating and manual embedding, as described above in connection with the method for installing a single staple. A strip form of separable shaped staples can use the gripping member or member(s) to hold the strip of shaped staples in suitably shaped holders of a hand-held or mounted heating element. The heating element can then heat the entire strip of staples or any portion thereof for embedding a plurality of shaped staples. When released, the shaped staples begin to cool in situ as the thermoplastic component material contacted by the staples cools and solidifies.

Once cooled, the area repaired by the shaped staples and in which the staple has been embedded can be sanded, filled with conventional body filler and otherwise finished in conventional manner. Preferably, staples are embedded according to the present invention from the inside, i.e., back side or the interior side that is generally not painted and presented as the exterior of the part, in order to reduce the amount of surface finishing. In certain situations where access to the interior surface is inaccessible, difficult or not economically warranted, the shaped staples of the present invention can be embedded into the thermoplastic component from the exterior or outside surface.

An alternative to the use of embeddable generally planar staples are plates that have been stamped, punched or otherwise formed to exhibit a plurality of teeth extending from one side of the planar staple or plate. Once heated with a suitable torch, iron or source of heat energy to a temperature above the melting point of the thermoplastic component, the teeth are placed across the cracked, broken or weakened area of the thermoplastic component and driven into the sound surrounding surface thereof. The plurality of heated teeth will melt into the thermoplastic and, when cooled, the plate will be firmly fused into the thermoplastic component. The size of the generally planar staple or plate, the number and depth of the teeth as well as their orientations can be adjusted to accommodate the size and shape of the damaged area in the thermoplastic component. For example, a relatively thin crack in a generally flat panel of 5 mm thickness might be able to use a rectangular plate having a plurality of 3 mm teeth while a crack in a curved section of a bumper that is also 5 mm thick might need a plurality of staples that are

A variety of materials can be used to make the shaped staples that are useful in the present invention. Suitable materials include, but are not limited to: metals, metal alloys, high temperature composites (see, e.g., U.S. Pat. Nos. 7,658,781 and 7,642,336), ceramics, photocurable pre-ceramic composites (see, e.g., U.S. Pat. No. 7,658,778) and thermoset plastics that can retain structural integrity at elevated temperatures in the form of single or multiple wire stock, braided wires, rod or sheet stock and foils. The most preferred materials for the shaped staples are single or braided metal wires or stamped that are formed into a suitable shape and detachably secured to adjacent staples in the form of a strip or coil of shaped staples.

A variety of tools and methods can be used to heat the staples or plates used in the present invention. The choice of any specific method or device will depend substantially on the frequency that repairs of thermoplastic components is required, the training time available for repair personnel and the availability of a nearby electrical outlet. Suitable heat sources include electrical resistance heating, inductive heating, hot coals and open flame. The preferred heat source is a handheld, resistance heater with jaws that will grip a vertically extended gripping member associated with the staple or plate. Even more preferred is a handheld resistance heater with a magnetic or electromagnetic surface that is sufficiently strong to hold a hot, metallic staple or plate in position as the repair is performed on the thermoplastic component. An electromagnetic system is preferred because it permits the staple or plate to be released by turning off the current to the electromagnet.

### DESCRIPTION OF THE FIGURES

The attached figures are conveniently used to describe additional details of the invention.

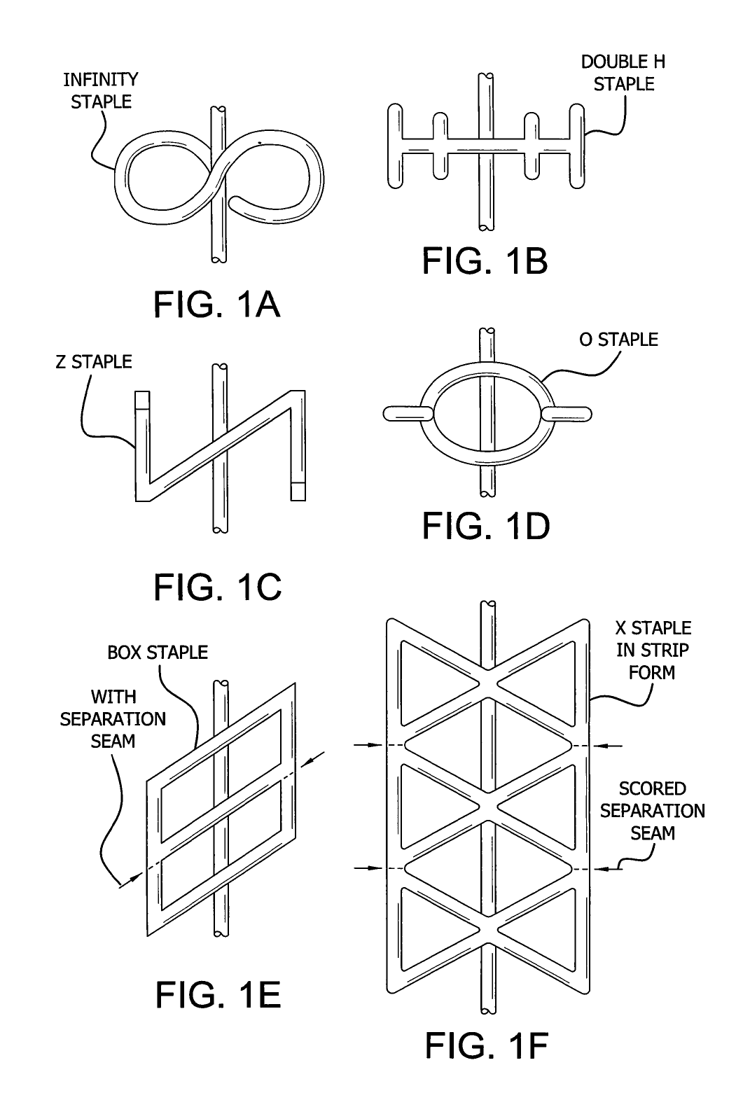

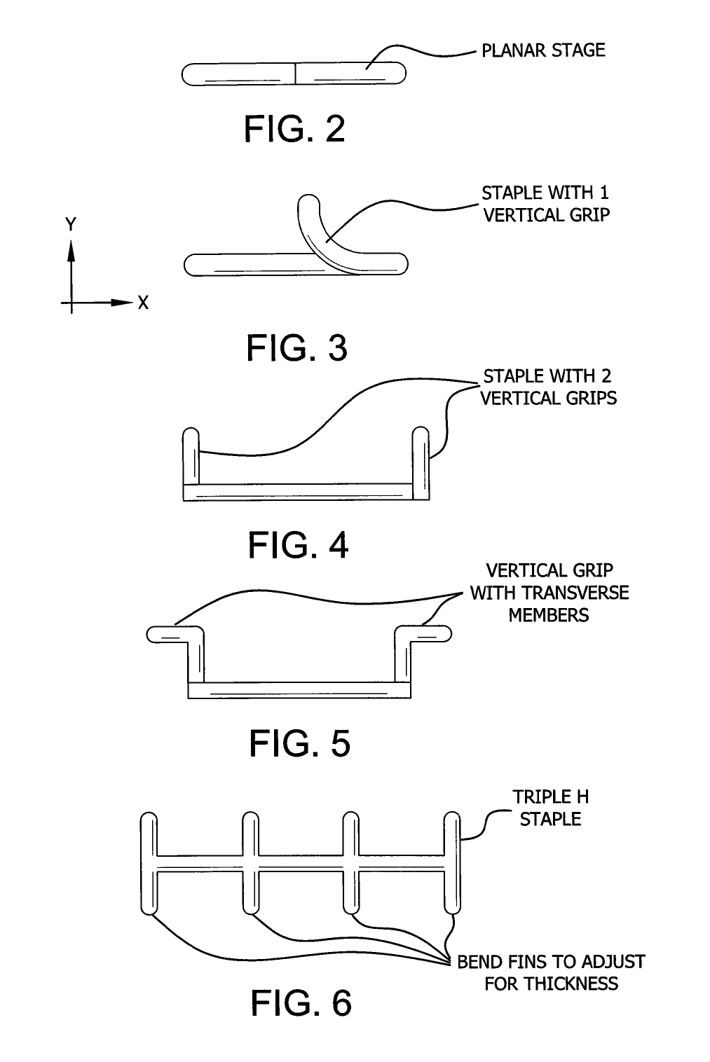

FIG. 1 shows a variety of suitable shapes for the embedded staples of the present invention. From top to bottom, the following shaped staples according to the invention are illustrated an infinity symbol staple optionally with a vertical grip for holding the staple while heating (FIG. 1A and FIGS. 2-3), a double “H” staple (FIG. 1B), a “Z” staple with two vertical grips suitable for holding the staple during heating (FIG. 1C and FIG. 4), a circular or “O” shaped staple with two vertical grips having transverse members to help push the hot staple into the thermoplastic component (FIG. 1D and FIG. 5), a double box-shaped staple with a score line as a separation seam for removing excess staples from a strip or roll of multiple, connected staples (FIG. 1E), a set of three “X”-shaped, interconnected staples which also have a score line between staples for separation of excess staples.

FIG. 6 shows a triple “H” shape of staple that has been stamped from metal stock of suitable shape. The triple H staple of FIG. 6 is generally narrow in width and exhibits a plurality of opposed or alternating (not shown) legs that can be used in a planar position for repairing relatively this thermoplastic components or can be bent downwardly and/or upwardly for repairing relatively thicker materials.

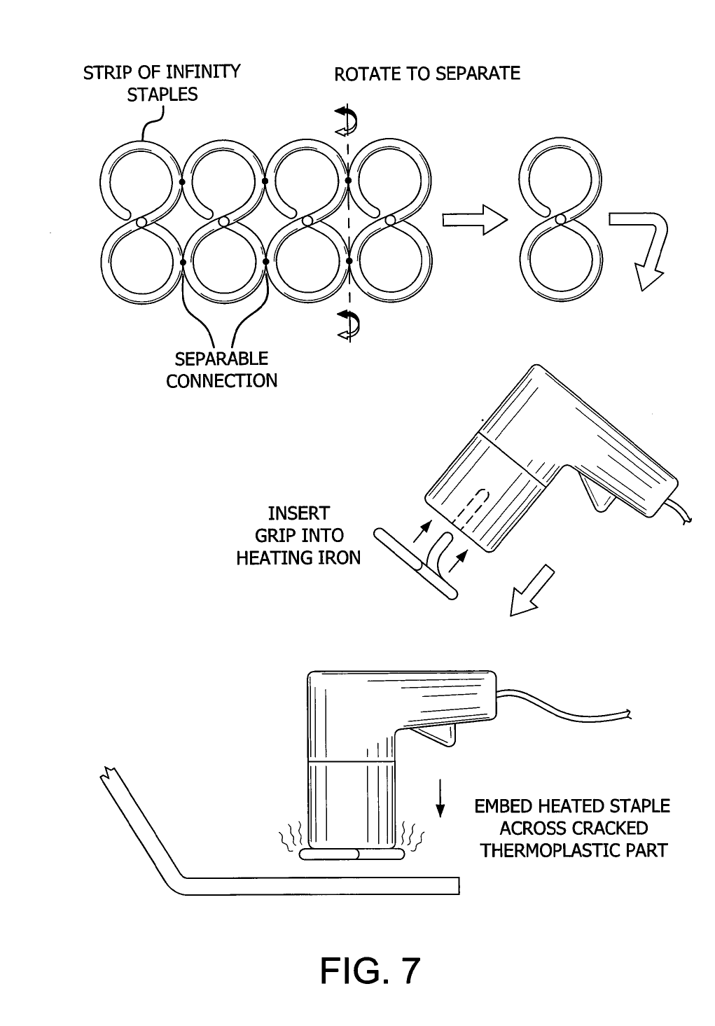

FIG. 7 depicts a strip of infinity-shaped, interconnected staples having a vertical grip formed from the metal wire stock used to form the staple. Rotation of the end staple relative to the strip of staples will cause the connection therebeween to break and release an individual staple for installation. The individual staple is then inserted, via its grip, into the gripping jaw of a handheld resistance heater that is capable of heating the staple to a temperature above the melting point of the thermoplastic material found in the component to be repaired.

It is anticipated that a handheld resistance heater having a wattage within the range of 500-2500 Watts would likely be sufficient for most staples and repairs.

The heated staple is then applied to the surface of the thermoplastic component across the break to be repaired. The size of the staple should be chosen to extend over the broken area and into undamaged material on either side to a distance of about 1-10 cm. The user of larger staples will form a stronger repair and may, depending on the thickness of the staple or plate used, increase stiffness in the repaired area.

The size, material and thickness of the staple should be selected so that the embedded staple remains within the thickness of the thermoplastic component and replicates, as closely as possible, the flexural characteristics of the surrounding material. This will reduce the localized stress points around the embedded staple and result in a repaired component that performs more similarly to the original component.

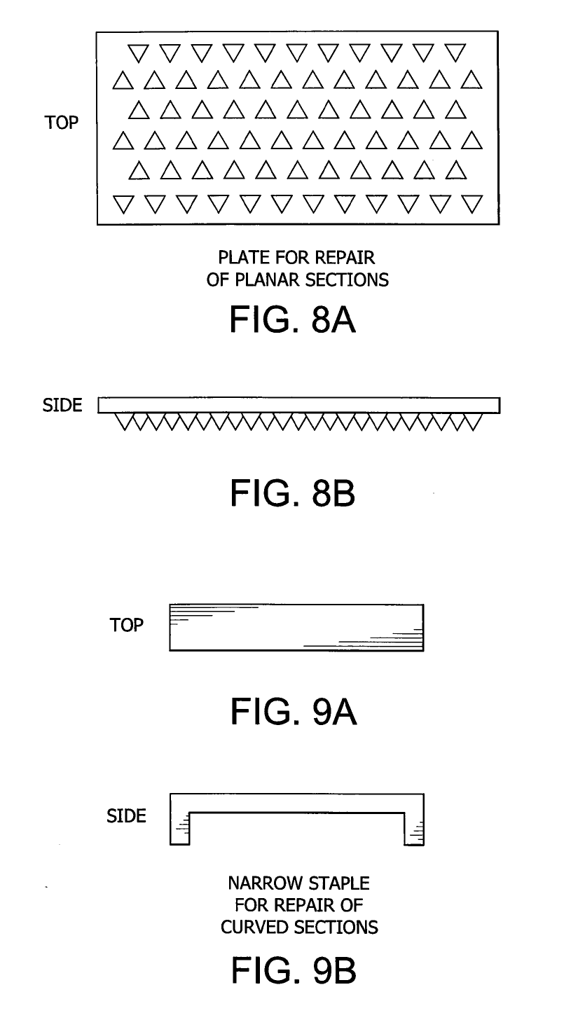

FIGS. 8 and 9 depict a toothed plate (FIG. 8) or relatively narrow, toothed staple (FIG. 9). These repair products are intended to be heated so that the teeth only are inserted into the thermoplastic component rather than having the entire staple buried within the component. It is envisioned that the heated planar portion of the staple or plate will come to rest on, and partially become fused to, the surface of the underlying thermoplastic component thereby enhancing repair strength from the increased surface area of bonded component.

The repair plate of FIG. 8 is shown with a series of triangular teeth that have been formed from a flat plate of metal in regular and irregular distribution areas. Preferably, this plate can be attracted by a magnet and held in place for heating and application to the area to be repaired. Such plates are good for repairs on relatively flat areas where added rigidity will not materially affect performance. If it does, the formed plate should be made with thinner material for greater flexibility but inserted into the thermoplastic component sufficiently deep that molten material exudes unto the openings formed in the plate.

The relatively narrow staple shown in FIG. 9 can be applied individually or from a strip or roll of interconnected staples. The relatively narrow width of the staple permits installation in areas of the thermoplastic component that are curved in a single plane. The same staple can be used for muliplanar curved area repairs but may need to be custom bent by the installer to conform as closely as possible to the repair surface.

What is claimed is:

1. A system for repairing thermoplastic components comprising (a) an embeddable, shaped staple that can be heated to a temperature above the melting point of a thermoplastic component to be repaired, said shaped staple having a length sufficient to bridge a defect area in said thermoplastic component and to become embedded into sound material on at least two sides of said defect area, and (b) a heating device that can apply sufficient heating energy to said shaped staple to produce a staple temperature that is sufficiently high to melt said thermoplastic component.

2. A method for repairing a defect in a thermoplastic bumper with a step comprising: embedding a heated, shaped staple or plate across a defect area in said bumper and into sound material on at least two sides of said defect area whereby, when cooled, said shaped staple or plate joins together said sound material on said at least two sides.

3. A method according to claim 2 wherein said shaped staple has a FIG. 8, infinity, H, double H, Z, O, box, or X shape.

4. A method according to claim 3 wherein said shaped staple has been separated from a strip of interconnected staples.

5. Shaped staples that can maintain structural integrity when heated to a temperature above the melting point of thermoplastic material used in an automotive bumper and exhibiting an elongated shape of a FIG. 8, infinity, H, double H, Z, O, box, or X shape.
